(19) United States
(12) Patent Application Publication
(10) Pub. No.: US 2005/0219669 A1
(43) Pub. Date: Oct. 6, 2005

(54) Method of forming a rainbow security hologram

(75) Inventors: Sushil Kumar Kaura, Chandigarh (IN); Dharam Pal Chhachhia, Chandigarh (IN); Anil Kumar Aggarwal, Chandigarh (IN); Ram Prakash Bajpai, Chandigarh (IN)

Correspondence Address: MERCHANT & GOULD PC, P.O. BOX 2903, MINNEAPOLIS, MN, 55402-0903, US

(73) Assignee: COUNCIL OF SCIENTIFIC AND INDUSTRIAL, New Delhi (IN)

(21) Appl. No.: 10/814,108

(22) Filed: Mar. 31, 2004

(51) Int. Cl. G03H 1/04

(52) U.S. Cl. 359/22; 430/1; 430/2; 359/12

(57) ABSTRACT

The present invention relates to a method of forming and validating a color-assigned rainbow security hologram of an object, where different parts of the recreated image of the object is presented to a viewer in different pre-chosen or assigned colors such that a novel in-built security verification/identification feature is encrypted/incorporated into these holograms, which can only be read/verified be using an encoded key hologram.

### FIELD OF THE INVENTION

The present invention relates to a method of forming and validating a color-assigned rainbow security hologram of an object, where different parts of the recreated image of the object is presented to a viewer in different pre-chosen or assigned colors such that a novel in-built security verification/identification feature is encrypted/incorporated into these holograms, which can only be read/verified be using an encoded key hologram.

The method of the present invention is useful for commercial and industrial applications and is particularly useful for making counterfeit-proof security emboss hologram masters, where a new type of rainbow security hologram is required which is sometimes referred to as color-assigned rainbow security hologram. The typical property and important advantage of these color-assigned rainbow security holograms is that the different parts of the recreated image of the object is presented to a viewer in different pre-chosen or assigned colors such that a novel in-built security verification/identification feature is encrypted/incorporated into these holograms which can only be read/verified by using an encoded key hologram in the reading process thereby making them suitable for both visual and as well as machine inspection and also in preventing the duplication/counterfeiting of these holograms.

### BACKGROUND AND PRIOR ART DESCRIPTION

In recent years, emboss holograms, enabling multi-colored visual inspection, have been widely used as security seals on various products to guard against duplication as well as on valuable documents to protect against forgery. One of the important steps in the production of emboss holograms involve the development of rainbow hologram masters. The rainbow holograms are normally formed by using a two-step recording process. Here, a master hologram of an object (O) is constructed in the first step with a conventional off-axis hologram recording technique. In the second step, this master hologram is used to form the rainbow hologram. For forming this, the master hologram is masked with a suitable horizontal slit aperture, and a real image of ‘O’ (with unit magnification) is projected onto the rainbow hologram recording plate. This real image serves as the input object field in making the rainbow hologram. On illumination with white-light, these holograms provide clear, sharp, colorful and deep images. As the viewer moves his head up or down, the color of the image appears to change throughout the spectrum (thus the name rainbow hologram). Thus, in a regular rainbow hologram, the entire image will appear in one given color for a particular view point and the viewer does not have any choice of seeing any particular portion of the object in a desired color. Further, due to the rapid technological advances especially in the area of computers, CCD-technology, image processing software, color scanners, printers and copiers etc, it is visualized that the counterfeiters may find it increasingly simple to acquire a holographic pattern/image from an embossed security hologram and subsequently may be able to synthesize a counterfeit/duplicate hologram by using commercially available hologram producing equipment.

In view of wide ranging commercial and industrial “applications and also for making counterfeit-proof security emboss hologram masters, a new type of color-assigned rainbow security hologram is required. Thus, methods for making color-assigned rainbow security holograms, with a typical property and important advantage of presenting the different parts of the recreated image of the object to a viewer in different pre-chosen or assigned colors such that a novel in-built security verification/identification feature is encrypted/incorporated into these holograms which can only be read/verified by using an encoded key hologram in the reading process and thereby making them suitable for both visual and as well as machine inspection and also in preventing the duplication/counterfeiting of these holograms, have been strongly demanded.

### OBJECT OF THE INVENTION

The main object of the present invention is to provide a simple, cost effective and reliable method for making color-assigned rainbow security holograms, where different parts of the recreated image of the object is presented to a viewer in a different pre-chosen or pre-assigned colors such that a novel in-built security verification/identification feature is encrypted into these holograms, which can only be read/verified be using an encoded key hologram.

Another object of the present invention is to provide a method for making color-assigned rainbow security holograms, which are suitable for both visual and as well as machine inspection.

Yet another object of the present invention is to provide a method for making color-assigned rainbow security holograms which are useful for security applications and also in preventing the duplication/counterfeiting of these holograms.

### SUMMARY OF THE INVENTION

To attain the above described objects, the present invention provides a simple, cost effective and reliable method for making color-assigned rainbow security holograms, where different parts of the recreated image of the object is presented to a viewer in different pre chosen or assigned colors such that a novel in-built security verification/identification feature is encrypted into these holograms, which can only be read/verified be using an encoded key hologram. In addition the present invention provides a method for making color-assigned rainbow security holograms which are suitable for both visual and as well as machine inspection and are useful for security applications and also in preventing the duplication/counterfeiting of these holograms.

### DETAILED DESCRIPTION OF THE INVENTION

Accordingly, the present invention provides a method of forming a rainbow security hologram of an object having different colors assigned at different locations on the object, said method comprising the step of forming different parts of the object with different grating values, wherein the grating value at a particular location determines the color assigned to said location.

More particularly, the present invention provides a method of forming a rainbow security hologram of an object having different colors assigned at different locations, said method comprising the steps of
(a) splitting a coherent light into a reference beam and one object beam;
(b) directing the reference beam and the object beam along separate paths such that the reference beam and the object beam interferes on a photo sensitive material on which the hologram is to be formed, and
(c) essentially directing the reference beam directly on the photo sensitive material and the object beam to pass through a Slit Master Hologram (SMH) recording plate having the object formed on it wherein different parts of the object are formed by different grating values on the SMH, before the same interferes with the reference beam on the photo sensitive material.

In an embodiment of the present invention wherein in step (a), the coherent light is a laser beam.

In another embodiment of the present invention wherein in step (a), wherein laser beam is generated by a He—Ne laser or a high intensity laser diode.

In yet another embodiment of the present invention wherein in step (a), the laser beam is split into a reference beam & an object beam by a variable beam splitter.

In still another embodiment of the present invention wherein in step (b), the reference beam and the object beam are directed along separate paths using plurality of reflecting surfaces.

In a further embodiment of the present invention the reference beam and the object beam are directed along separate paths using at least two reflecting surfaces.

In a further more embodiment of the present invention the reflecting surfaces are complete or partial reflecting surfaces.

In one more embodiment of the present invention, the reflecting surfaces are plane reflecting mirrors.

In one another embodiment of the present invention the reference beam and the object beam individually are optionally are allowed to pass through a beam expander and collimating lens before interfering on the photo sensitive material.

In another embodiment of the present invention the grating value at a particular location of the object formed on SMH determines the color assigned to said location of the object when formed on photo sensitive material.

In yet another embodiment of the present invention wherein in step (c), slit master hologram recording plate (SMH) has different grating value for different wavelength.

In still another embodiment of the present invention wherein the grating value for a particular wavelength of light at a predetermined angle of illumination and angle of view is give by the formula d=λ(Sin θ_{I}+Sin θᵥ) wherein θᵥ=angle of view, θi=angle of illumination, d is grating value and λ is wavelength of light.

The present invention also provides a method of authenticating/verifying a color assigned rainbow security hologram imposed with an image of an object, wherein different locations of the object have different pre assigned colors using which an authenticating hologram is prepared, said method comprising the steps of
(a) obtaining a reference beam;
(b) projecting the reference beam through a Slit Master Hologram (SMH) to obtain a decoding reference beam,
(c) projecting the decoding beam on to the hologram which is to be authenticated such that an image of the object is formed, and
(d) verifying the image thus formed using a photo detector to authenticate the hologram.

In an embodiment of the present invention wherein in step (a), the reference beam is obtaining from source of He—Ne laser or high intensity laser diode.

In another embodiment of the present invention wherein in step (b), the reference beam is allowed to pass through a beam expander and a collimating lens before passing through Slit Master Hologram (SMH).

In still another embodiment of the present invention wherein in step (b), slit master hologram recording plate (SMH) has different grating value for different wavelength.

In yet another embodiment of the present invention wherein in step (c), verification includes analyzing the of the image formed and authenticating the hologram if the colors of various parts of the images formed are in a pre assigned format.

In a further embodiment of the present invention wherein in step (c), verification includes the steps of
(a) analyzing the colors of various parts of the image;
(b) matching the colors of various parts of the image with a pre assigned format, and
(c) verifying the hologram to be authenticate if the colors of various parts of the image are in the pre assigned format.

In one more embodiment of the present invention wherein in step (d), the photo detector is placed at the position where reconstructed image of the object is formed.

In another embodiment of the present invention wherein in step (d), the photo detector is used in conjunction with a threshold circuit for verifying the image formed.

In a further more embodiment of the present invention the method of authenticating/verifying is used for machine inspection in addition to visual inspection for color assigned security hologram.

For making color-assigned rainbow security holograms having the properties as described above, a decision is first made as to which parts of the object the viewer wants to see in different pre assigned colors at a particular viewing position. Accordingly the desired different colors are assigned to the different parts of the object, which the viewer would ultimately be presented in the final image. Now in the first recording step of the method (FIG. 1 and FIG. 2), three spatially separated slit master holograms (SMH), for pre assigned different parts of the object, are formed on the same hologram recording plate using an off-axis hologram recording technique. This SMH plate is then used in the second recording step of the method (FIG. 3) to construct a color-assigned rainbow security hologram. Here in this case, for encryption/incorporation of a novel in-built security verification/identification feature into these holograms, a convergent reference beam is used to make the color-assigned rainbow security holograms.

On illumination with white-light, these color-assigned rainbow security holograms provide different parts of the recreated image of the object to a viewer in different pre chosen or assigned colors at a particular view point. The authenticity of these color-assigned rainbow security holograms is verified/identified by using an encoded key hologram in the final reading process (FIG. 4). Here in this case, the slit master holograms (SMH) recorded plate, as formed in the first recording step of the method, serves as the encoded key hologram. In this final reading process, a sharp focus (bright spot) emerges only when the decoding reconstructing beam generated from the encoded key hologram illuminates an authentic color-assigned rainbow security hologram. In this case, with a photo-electric detector, used in conjunction with a threshold circuit, placed at the position of reconstructed sharp focus (bright spot) facilitates automatic verification/identification of the authenticity of the color-assigned rainbow security holograms thereby making them suitable for machine inspection in addition to visual inspection.

The invention accordingly comprises the features of the above-described objects and relates to the development and investigation of a method for making color-assigned rainbow security holograms and the scope of the invention will be indicated in the claims.

### BRIEF DESCRIPTION OF THE DRAWINGS

FIG. 1 is a schematic view of a configuration of a recording set up for making slit master holograms according to a first embodiment of the invention. The various parts of the configuration have been labeled as under:

1 He—Ne laser

2 Variable beam splitter

3,4 Plane reflecting mirror

5 Spatial filter assembly

6 Beam expander

7 Collimating lens

8 3-D Object

9 Collimated reference beam

10 Slit master hologram recording plate

FIG. 2 is a schematic of a partially cutaway orthogonal view of a recording set up for making slit master holograms shown in FIG. 1. The various parts of the configuration have been labeled as under:

1 Object beam

2 Collimated reference beam

3 3-D Object

4 Slit master hologram recording plate

FIG. 3 is a schematic view of a configuration of recording set up for making colour-assigned rainbow security hologram according to a second embodiment of the invention. The various parts of the configuration have been labeled as under:

1 He—Ne laser

2 Variable beam splitter

3,4,5 Plane reflecting mirror

6 Spatial filter assembly

7,8,10 Collimating lens

9 Beam expander

10 Slit master hologram

12 Object beam

13 Convergent reference beam

14 Colour-assigned rainbow security hologram recording plate

FIG. 4 is a schematic view of a configuration of reading set up for authenticity verification/identification of colour-assigned rainbow security holograms according to a third embodiment of the invention. The various parts of the configuration have been labeled as under:

1 He—Ne laser

2 Beam Expander

3 Collimating lens

4 Collimated reading beam

5 Encoded key hologram [Here slit master holograms (SMH) recorded plate, as formed in the first recording step, serves as an encoded key hologram]

6 Decoding reconstructing beam

7 Colour-assigned rainbow security hologram

8 Photo-electric detector

9 Threshold circuit

### DETAILED DESCRIPTION OF THE PREFERRED EMBODIMENTS

Embodiments of the invention will now be described in detail with reference to the accompanying drawings, which are given by way of illustration and the same should not be construed to limit the scope of the invention in any manner. As it can be evident, a person skilled in the art would be able to create gratings of different values by different methods such as by using a computer controlled laser beam thus, the scope of the present invention is not intended to be restricted by the methods described here below and is only restricted by claim 1 which defines the novel and inventive feature of the present invention.

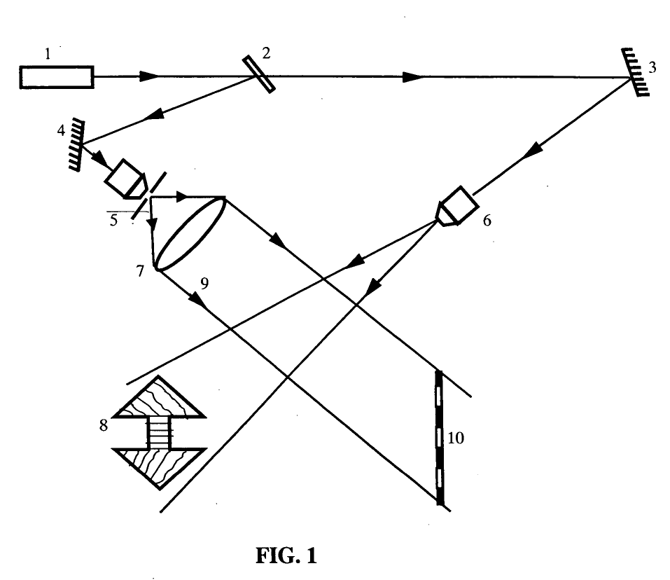

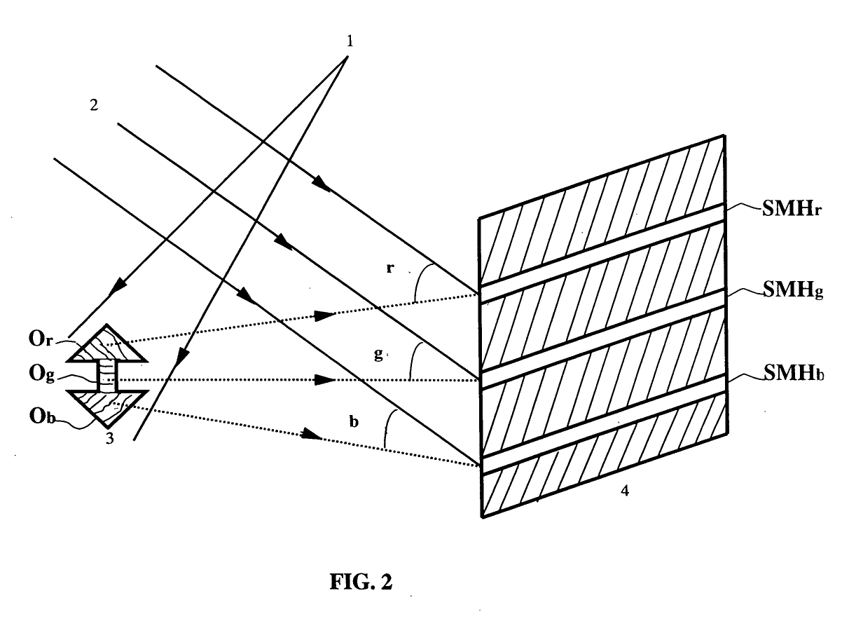

FIG. 1 is a schematic view of a configuration of a recording set up for making slit master holograms according to a first embodiment of the invention. FIG. 2 is a schematic of a partially cutaway orthogonal view of a recording set up for making slit master holograms shown in FIG. 1. It may be noted that a recorded hologram can also be considered to be a form of complex grating, satisfying the following equation:
Sin θi+Sin θv=λ/d
where θi is angle of illumination, θv is angle of view, λ is wavelength of light, and d is grating spacing.

As shown in FIG. 1 and FIG. 2, the first recording step of the method involves formation of three spatially separated slit master holograms (SMH), for pre assigned different parts of the object, on the same hologram recording plate using a conventional off-axis hologram recording technique. For this a decision is first made as to which parts of the object the viewer wants to see in different assigned colours at a particular viewing position. Accordingly the desired different colours are assigned to the different parts of the object, which the viewer would ultimately be presented in the final image.

Consider a typical situation, where the viewer wants to see one part of the object in red colour (labeled as ‘Oᵣ’), second part of the object in green colour (labeled as ‘O_{g}’) and third part of the object in blue colour (labeled as ‘Ob’). Now a slit master hologram (SMHr) for the red assigned colour is first made by using the object part ‘Oᵣ’ only while masking the object parts ‘O_{g}’ and ‘Ob’ and other portions of the slit master hologram (SMH) recording plate. Then, slit master hologram (SMHg) for green assigned colour is made, by using the object part ‘O_{g}’ only while masking the object parts ‘Oᵣ’ and ‘Ob’ and other portions of the SMH recording plate. Similarly slit master hologram (SMHb) for blue assigned colour is made by using the object part ‘Ob’ only while masking the object parts ‘Oᵣ’ and ‘O_{g}’ and other portions of the SMH recording plate. This SMH plate is subsequently used in the second recording step of the method to construct a colour-assigned rainbow security hologram. In order to get the entire object parts ‘Oᵣ’, ‘O_{g}’ and ‘Ob’ imaged in assigned red, green and blue colours simultaneously at the desired viewing zone, we have used the grating equation (1). By using equation (1), we observe that for a typical value of angle ‘6i ’, we wish to get the value of angle ‘9v’ constant for all the three red, green and blue (Xr, Xg, Xb) coloured images. For achieving this, we are required to change the value of ‘d’ [the grating (hologram) spacing] for different AT, Xg, and Xb. Different values of ‘d’ {‘dr’ for Xr, ‘dg’ for Xg and ‘db’ for Xb} are obtained by altering the angles ‘6r between ‘Oᵣ’ and reference beam; ‘6g’ between ‘O_{g}’ and reference beam; ‘0b’ between ‘O_{b}’ and reference beam while making the three spatially separated, ‘SMHr’, ‘SMHg’ and ‘SMHb’ on the same SMH recording plate in the first recording step of the method.

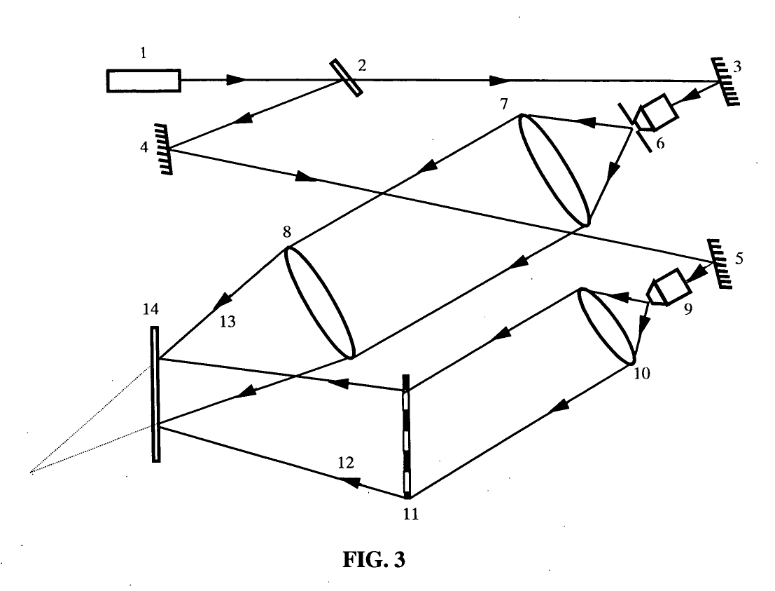

FIG. 3 is a schematic view of a configuration of recording set up for making colour-assigned rainbow security holograms according to the second embodiment of the invention. As shown in the figure, the SMH plate (as formed in the first recording step of the method) is now used in the second recording step of the method to construct a colour-assigned rainbow security hologram. The real image derived from the SMH plate, which serves as the input object field, in conjunction with a convergent reference beam (13) is used in the construction of a colour-assigned rainbow security hologram (14). The use of convergent reference beam, in this recording step of the method, also facilitates in the encryption/incorporation of a novel inbuilt security verification/identification feature into these colour-assigned rainbow security holograms.

On illumination with white-light, these colour-assigned rainbow security holograms provide different parts of the recreated image of the object to a viewer in different pre chosen or assigned colours at a particular view point.

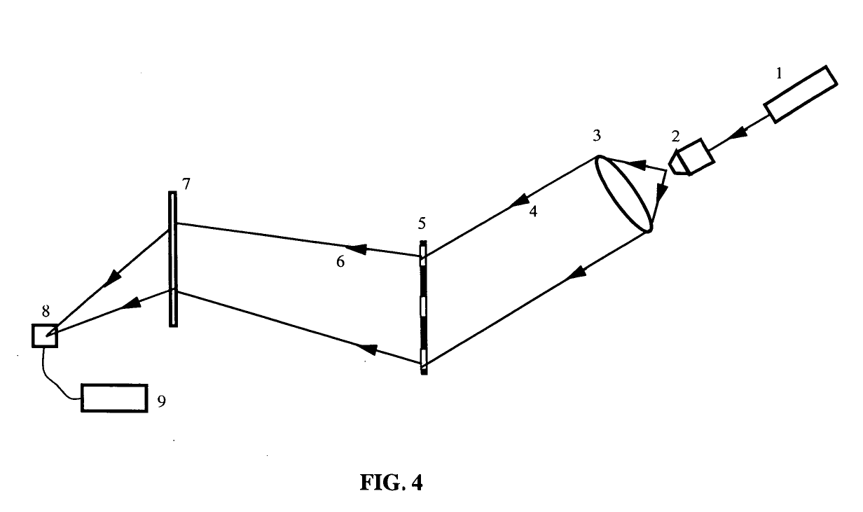

FIG. 4 is a schematic view of a configuration of reading set up for authenticity verification/identification of colour-assigned rainbow security holograms according to a third embodiment of the invention. The authenticity of these colour-assigned rainbow security holograms is verified/identified by using an encoded key hologram in the final reading process. Here in this case, the slit master holograms (SMH) recorded plate, as formed in the first recording step of the method, serves as the encoded key hologram. In this final reading process, a sharp focus (bright spot) emerges only when the decoding reconstructing beam (6) generated from the encoded key hologram (5) illuminates an authentic colour-assigned rainbow security hologram (7). In this case, with a photo-electric detector (8), used in conjunction with a threshold circuit (9), placed at the position of reconstructed sharp focus (bright spot) facilitates automatic verification/identification of the authenticity of these colour-assigned rainbow security holograms thereby making them suitable for machine inspection in addition to visual inspection.

We have successfully made the colour-assigned rainbow security holograms by using this invented method in our laboratory.

Here a method for making colour-assigned rainbow security holograms according to the present invention has been described above on the basis of the principles and embodiments thereof.

It is clear from the foregoing description that the method for making colour-assigned rainbow security holograms according to the invention is advantageous in that it provides a simple, cost effective and reliable method for making colour-assigned rainbow security holograms, where different parts of the recreated image of the object is presented to a viewer in different pre-chosen or assigned colours such that a novel inbuilt security verification/identification feature is encrypted/incorporated into these holograms, which can only be read/verified be using an encoded key hologram.

In addition the method for making colour-assigned rainbow security holograms according to the invention is advantageous in that it provides a method for making colour-assigned rainbow security hologram which are suitable for both visual and as well as machine inspection, and are useful for security applications and also in preventing the duplication/counterfeiting of these holograms.

1. A method of forming a rainbow security hologram of an object having different colors assigned at different locations on the object, said method comprising the step of forming different parts of the object with different grating values, wherein the grating value at a particular location determines the color assigned to said location.

2. A method of forming a rainbow security hologram of an object having different colors assigned at different locations, said method comprising the steps of
a. splitting a coherent light into a reference beam and one object beam;
b. directing the reference beam and the object beam along separate paths such that the reference beam and the object beam interferes on a photo sensitive material on which the hologram is to be formed; and
c. essentially directing the reference beam directly on the photo sensitive material and the object beam to pass through a Slit Master Hologram (SMH) recording plate having the object formed on it wherein different parts of the object are formed by different grating values on the SMH, before the same interferes with the reference beam on the photo sensitive material.

3. A method as claimed in claim 2 wherein in step (a), the coherent light is a laser beam.

4. A method as claimed in claim 2 wherein in step (a), wherein laser beam is generated by a He—Ne laser or a high intensity laser diode.

5. A method as claimed in claim 2 wherein in step (a), the laser beam is split into a reference beam & an object beam by a variable beam splitter.

6. A method as claimed in claim 1, wherein in step (b), the reference beam and the object beam are directed along separate paths using plurality of reflecting surfaces.

7. A method as claimed in claim 6, wherein the reference beam and the object beam are directed along separate paths using at least two reflecting surfaces.

8. A method as claimed in claim 6, wherein the reflecting surfaces are complete or partial reflecting surfaces.

9. A method as claimed in claim 6, wherein the reflecting surfaces are plane reflecting mirrors.

10. A method as claimed in claim 2, wherein the reference beam and the object beam individually are optionally are allowed to pass through a beam expander and collimating lens before interfering on the photo sensitive material.

11. A method as claimed in claim 2, wherein the grating value at a particular location of the object formed on SMH determines the color assigned to said location of the object when formed on photo sensitive material.

12. A method as claimed in claim 1 wherein in step (c), slit master hologram recording plate (SMH) has different grating value for different wavelength.

13. A method as claimed in claim 12, wherein the grating value for a particular wavelength of light at a predetermined angle of illumination and angle of view is give by the formula d=λ/(Sin θ_{I}+Sin θᵥ) wherein θᵥ=angle of view, θi=angle of illumination, d is grating value and λ is wavelength of light.

14. A method of authenticating/verifying a color assigned rainbow security hologram imposed with an image of an object, wherein different locations of the object have different pre assigned colors using which an authenticating hologram is prepared, said method comprising the steps of
a. obtaining a reference beam;
b. projecting the reference beam through a Slit Master Hologram (SMH) to obtain a decoding reference beam,
c. projecting the decoding beam on to the hologram which is to be authenticated such that an image of the object is formed, and
d. verifying the image thus formed using a photo detector to authenticate the hologram.

15. A method of authenticating/verifying as claimed in claim 14, wherein in step (a), the reference beam is obtaining from source of He—Ne laser or high intensity laser diode.

16. A method of authenticating/verifying as claimed in claim 14 wherein in step (b), the reference beam is allowed to pass through a beam expander and a collimating lens before passing through Slit Master Hologram (SMH).

17. A method of authenticating/verifying as claimed in claim 14 wherein in step (b), slit master hologram recording plate (SMH) has different grating value for different wavelength.

18. A method of authenticating/verifying as claimed in claim 14 wherein in step (c), verification includes analyzing the of the image formed and authenticating the hologram if the colors of various parts of the images formed are in a pre assigned format.

19. A method of authenticating/verifying as claimed in claim 14 wherein in step (c), verification includes the steps of
a) analyzing the colors of various parts of the image.
b) matching the colors of various parts of the image with a pre assigned format.
c) verifying the hologram to be authenticate if the colors of various parts of the image are in the pre assigned format.

20. A method of authenticating/verifying as claimed in claim 14 wherein in step (d), the photo detector is placed at the position where reconstructed image of the object is formed.

21. A method of authenticating/verifying as claimed in claim 14 wherein in step (d), the photo detector is used in conjunction with a threshold circuit for verifying the image formed.

22. A method of authenticating/verifying as claimed in claim 14, is used for machine inspection in addition to visual inspection for color assigned security hologram.
